(19) United States
(12) Patent Application Publication
(10) Pub. No.: US 2026/0240707 A1
(43) Pub. Date: Aug. 20, 2026

(54) ENVIRONMENTALLY CONSCIOUS CREMATION

(71) Applicant: Philip Fransioli Busby, Jr., Moffat, CO (US)

(72) Inventor: Philip Fransioli Busby, Jr., Moffat, CO (US)

(21) Appl. No.: 19/540,380

(22) Filed: Feb. 13, 2026

Related U.S. Application Data
(60) Provisional application No. 63/760,939, filed on Feb. 20, 2025.

(51) Int. Cl. A61G 17/007; A61G 17/08; B01D 46/00; B01D 46/58

(52) U.S. Cl. CPC A61G 17/0106; A61G 17/0073; A61G 17/0076; A61G 17/08; B01D 46/0005; B01D 46/58

(57) ABSTRACT

A crematory includes a floor as well as left side, rear, right side, and front walls rising from the floor and meeting at four corners to surround a lower chamber with ports passing through each of the walls to outside the lower chamber. A grate rests above the sidewalls and a rim rises from the side walls around an upper chamber above the grate. First, second, third and fourth columns rise from the rim above each of the four corners and a frame spans the columns to support a plurality of air filters.

### CROSS-REFERENCE TO RELATED APPLICATIONS

The disclosure claims the benefit of and incorporates herein by reference in its entirety U.S. Provisional Application Ser. No. 63/760,939 filed 20 Feb. 2025 and entitled ‘CREMATORY AND A METHOD OF USE THEREOF’, pending.

### SUMMARY

The disclosure describes a crematory. The crematory includes a floor as well as left side, rear, right side, and front walls rising from the floor and meeting at four corners to surround a lower chamber with ports passing through each of the walls to outside the lower chamber. A grate rests above the sidewalls and a rim rises from the side walls around an upper chamber above the grate. First, second, third and fourth columns rise from the rim above each of the four corners and a frame spans the columns to support a plurality of air filters.

The disclosure also describes a method for assembling a crematory. The method includes forming a floor and forming left side, rear, right side, and front walls so as to rise from the floor, meet at four corners and surround a lower chamber with ports passing through each of the walls to outside the lower chamber. The walls are spanned by a number of parallel cylinders. A grate is laid on the cylinders. A rim is formed so as to rise from the side walls above the grate around an upper chamber. First, second, third and fourth columns are formed so as to rise from the rim above each of the four corners. A plurality of air filters are framed and the columns are spanned by the framed air filters.

Further, the disclosure describes a crematory kit. The crematory kit includes a plurality of fire bricks, a plurality of solid cylinders, a grate, a frame and a plurality of air filters configured for secure receipt within the frame.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a perspective view of an example crematory.

FIG. 2 illustrates a front view of the example crematory of FIG. 1.

FIG. 3 illustrates a right side view of the example crematory of FIGS. 1 & 2.

FIG. 4 illustrates a top view of an example frame system suitable for use in association with disclosed crematories and filters.

FIG. 5 illustrates a top view of an example frame system with disclosed filters mounted.

FIG. 6 illustrates a cross-sectional view of an example crematory along a plane A-A shown in FIG. 3 in association with a crematory pit.

FIG. 7 illustrates a collection or kit of components suitable for use in association with disclosed crematories and associated methods.

FIG. 8 illustrates additional components suitable for use in association with the collection or kit of FIG. 7.

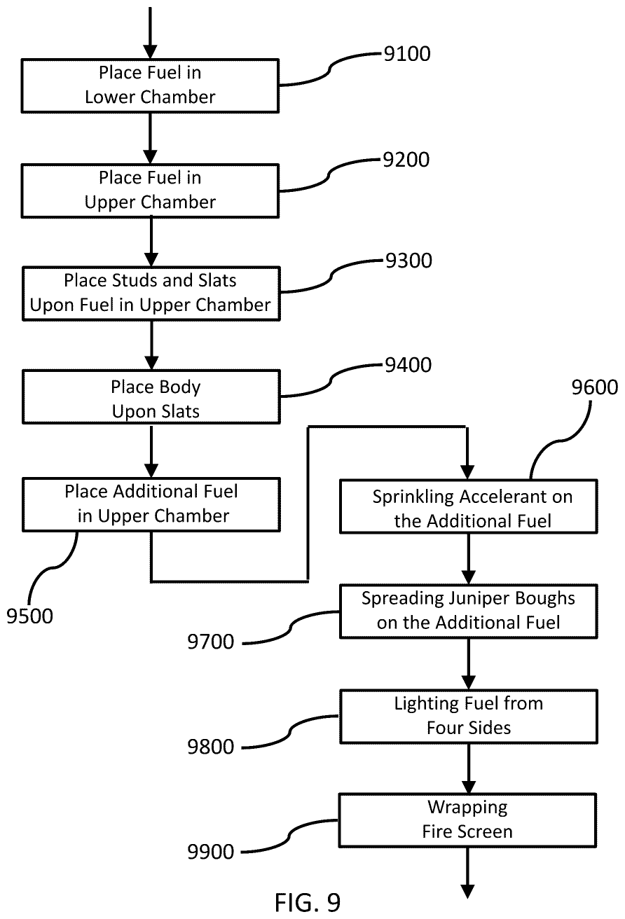

FIG. 9 illustrates a flow of an example method for using crematories.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Cremation has served as an alternative to burial of a body or corpse for nearly 20,000 years. In countries of the Western world, cremation has typically been carried out in an enclosed furnace that some argue is too industrialized and impersonal. With the objective of a more meaningful experience for the bereaved, some cremation providers have offered outdoor or open-air cremation services enabling a more intimate experience to the bereaved that also feels very natural. Known open-air crematories present risk for wildfire and air pollution.

Embodiments of the disclosure substantially eliminate, or at least partially address, problems in the prior art, enabling a crematory which mitigates wildfire risk and air pollution in an open-air setting. Some embodiments enable disassembly of a crematory after a cremation service so that the operation may be easily moved to a new location.

Additional aspects, advantages, features and objects of the disclosure will be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

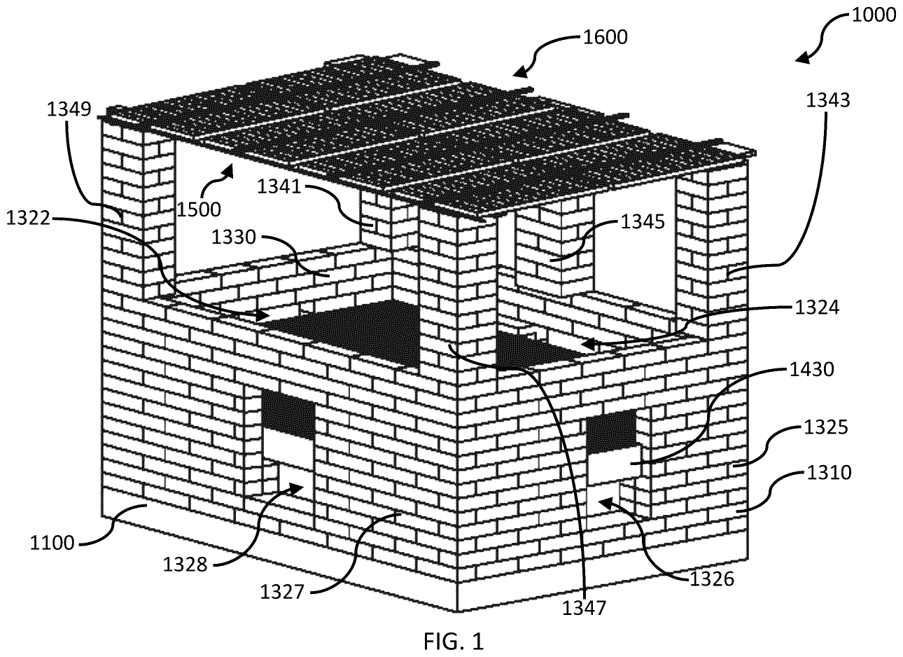

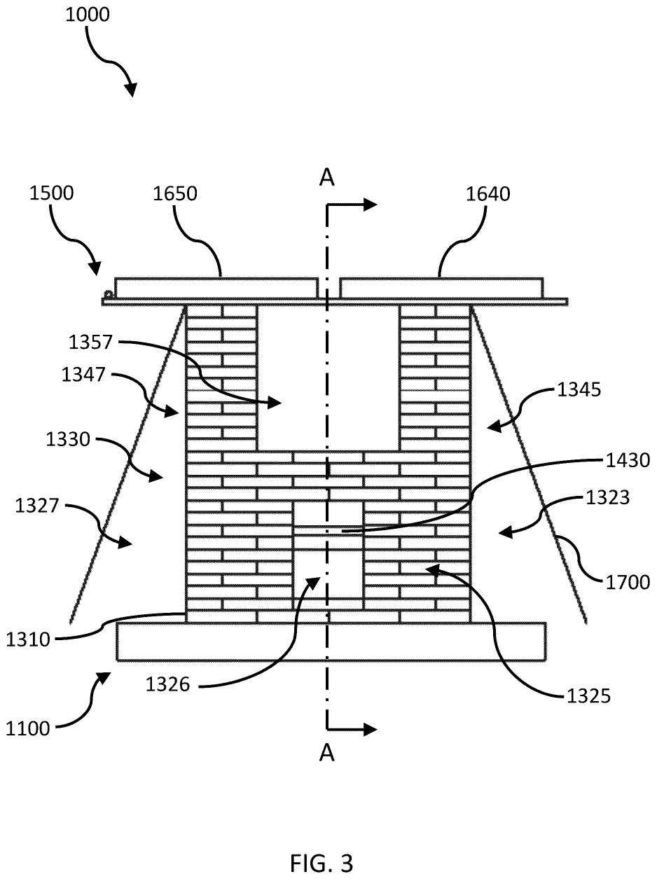

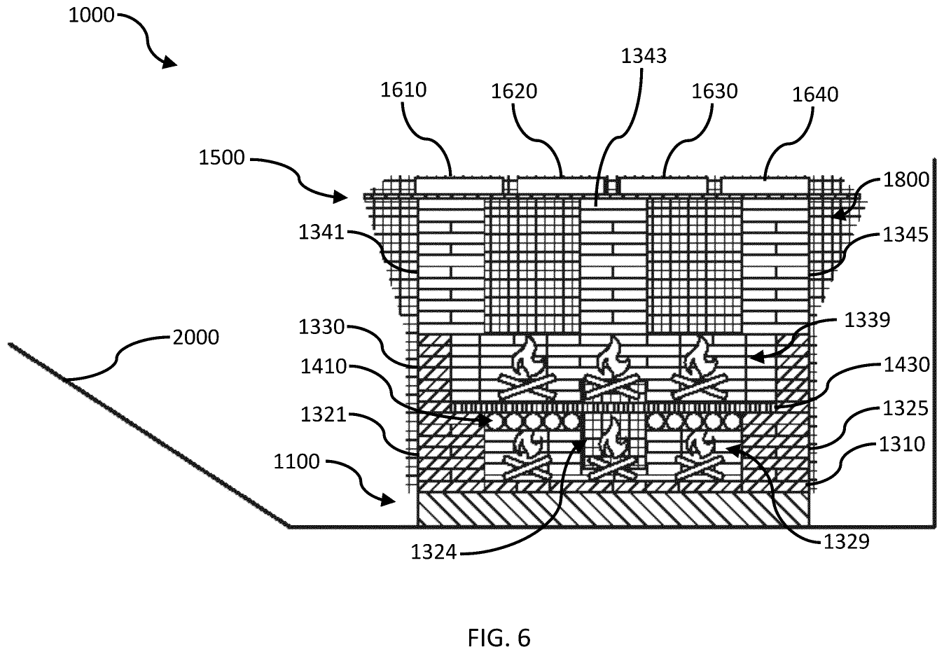

FIGS. 1-6 illustrate an example crematorium or crematory 1000 which may be of an outdoor or open-air variety rather than being enclosed within a structure. Crematory 1000 includes a pyre having a floor 1310 as well as a left side wall 1321, a rear wall 1323, a right side wall 1325 and a front wall 1327 rising from the floor and meeting at four corners to surround a lower chamber 1329. Left side port (not visible), rear port (not visible), right side port 1326 and front port 1328 passing through the walls to outside the lower chamber.

Floor 1310 may be laid onto a base or foundation 1100 with sand levelled between the foundation and the floor. In an example, foundation 1100 is a 1 ft. thick monolithic concrete slab embedded or impregnated with rebar and a 4 in. layer of sand is levelled on the slab.

A grate 1430 rests above walls 1321, 1323, 1325 & 1327 and a rim 1330 rises from the walls around an upper chamber 1339 above the grate. To facilitate portability, grate 1430 may be provided in a number of segments. In an example, grate 1430 is provided in three segments each measuring about 3 ft. by about 3.67 ft.

Grate 1430 may be supported by a plurality of cylinders 1410 spanning two of left side, rear, right side, and front walls 1321, 1323, 1325 & 1327. Any number of cylinders 1410 suitable to span most or substantially all of the length of the two walls may be provided which number will depend on cylinder diameter relative to the length of the two walls. In an example, 24 solid cylinders 1410 are provided to span front wall 1327 and rear wall 1323 to support grate 1430. Cylinders 1410 may be formed from any of a variety of heat-resistant and/or fire resistant materials including but not limited to metals such as steel.

Rim 1330 defining upper chamber 1339 above grate 1430 may be an extension of left side, rear and right side and front walls 1321, 1323, 1325 & 1327 to complete the pyre retort and provide radiation reflection or insulation regions extending upward from the grate away from floor 1310. The interior perimeter of lower chamber 1329 may be smaller than the interior perimeter of upper chamber 1339 thereby forming a ledge which supports spanning cylinders 1410. In an example, rim 1330 rises 16 in. above grate 1430 and the grate is supported 16 in. above floor 1310.

First, second, third and fourth columns 1341, 1343, 1347 & 1349 rise from the pyre at rim 1330 above each of the four corners of left side, rear, right side, and front walls 1321, 1323, 1325 & 1327. Crematory 1000 may further include a fifth, side or rear column 1345 rising from rim 1330 between first column 1341 and second column 1343 and extending upwards above rear wall 1323. In an example, first, second, third, fourth and fifth columns 1341, 1343, 1347, 1349 and 1345 rise or extend about 5-6 ft. above the upper surface or extent of rim 1330.

Floor 1310, walls 1321, 1323, 1325 & 1327, rim 1330 and columns 1341, 1343, 1345, 1347 & 1349 may be constructed by dry-stone masonry. Such construction allows for non-destructive disassembly of crematory 1000 after cremation and/or collection of cooled ashes. Floor 1310, walls 1321, 1323, 1325 & 1327, rim 1330 and columns may further include stacked fire bricks or refractory bricks. A combination of full-size bricks and half-size slat bricks or flat bricks may be used. For example, ports 1322, 1324, 1326 & 1328 may be enabled by an arrangement of full-size bricks and flat bricks. Floor 1310 may further include a matrix of refractory bricks or fire bricks.

Columns 1341, 1343, 1345, 1347 & 1349 may further include a series of levels each including a pair of the stacked fire bricks. The layers of fire brick pairs may be arranged in alternating stretcher and header configurations. Left side wall 1321, rear wall 1323, right side wall 1325 and front wall 1327 may each further include a plurality of layers of fire bricks. The plurality of layers may further include layers of alternating first and second types wherein the first type includes a plurality of fire bricks in stretcher configuration between end bricks in header orientation and the second type includes a plurality of fire bricks all in stretcher configuration. Rim 1330 may be formed on walls 1321, 1323, 1325 & 1327 with a series of single fire bricks in stretcher orientation such that each wall has a length which is a multiple of a fire brick length and a height which is a multiple of a fire brick height.

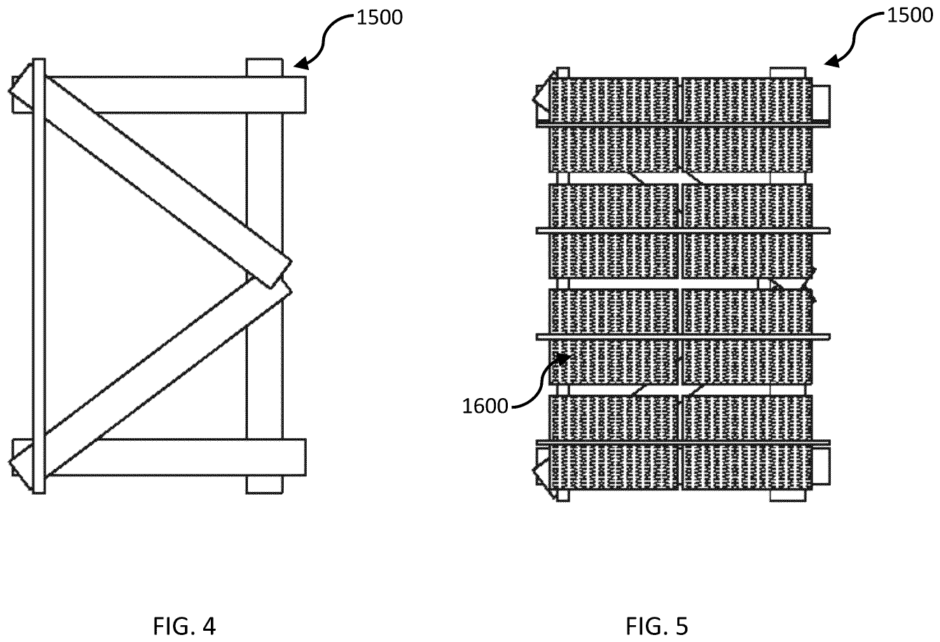

A roof or frame 1500 shown in detail by way of example in FIGS. 4 & 5 spans columns 1341, 1343, 1345, 1347 & 1349 to support a plurality of air filters 1600 installed to the frame. Air filters 1600 may be configured or constructed from or may include materials suitable for operating temperatures up to 900° F. In an example, air filters 1600 are constructed from or otherwise include stainless steel. Any number of air filters 1600 sufficient to substantially cover or span the area above the pyre and/or defined between five columns 1341, 1343, 1345, 1347 & 1349 may be provided. In an example, eight air filters 1610, 1620, 1630, 1640, 1650, 1660, 1670 and 1680 are provided to cover an area of approximately 4 ft. by 8 ft.

Crematory 1000 may further include guy lines 1700 coupled with roof or frame 1500 and anchored to static points around the crematory for stability during wind events. A first guy line 1700 may extend from a first anchor point upwards at an angle to a top of fourth column 1349, wrap the upper layer of the fourth column, extend to adjacent, third column 1347, wrap the upper layer of the third column and then extend downwards at an angle to a second anchor point. A second guy line 1700 may extend from a third anchor point upwards at an angle to a top of third column 1347, wrap the upper layer of the third column, extend to the adjacent second column 1343 while passing fifth column 1345, wrap the upper layer of the fourth column and then extend downwards at an angle to a fourth anchor point.

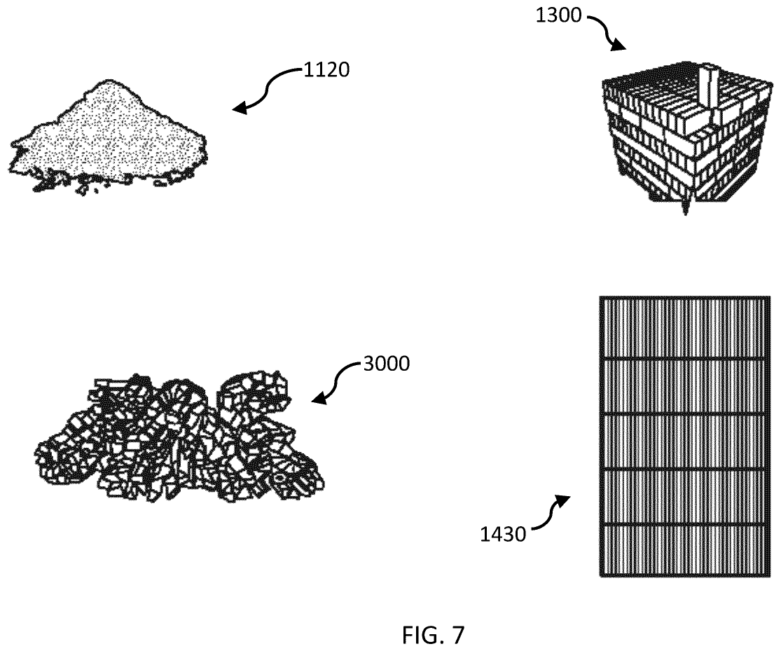

Referring to FIG. 6 which depicts a cross section along section plane A-A, example crematory 1000 includes a fire screen mesh 1800 omitted from FIGS. 1-3 for clarity. Fire screen mesh 1800 wraps columns 1341, 1343, 1345, 1347 & 1349 and windows 1351, 1353, 1355, 1357 & 1359 defined therebetween to surround the pyre. In an example, mesh 1800 may be applied before guy lines 1700 are strung between columns 1341, 1343, 1345, 1347 & 1349 and anchor points.

In cases where the body to be incinerated is relatively small and/or leaves an undesirable space inside rim 1330, crematory 1000, may further include or be provided with a stand-off configured to rest on grate 1430 inscribed by walls of the rim. In an example, the stand-off is provided as one or more layers of bricks configured to decrease the perimeter of the upper chamber and/or more closely surround the body or remains.

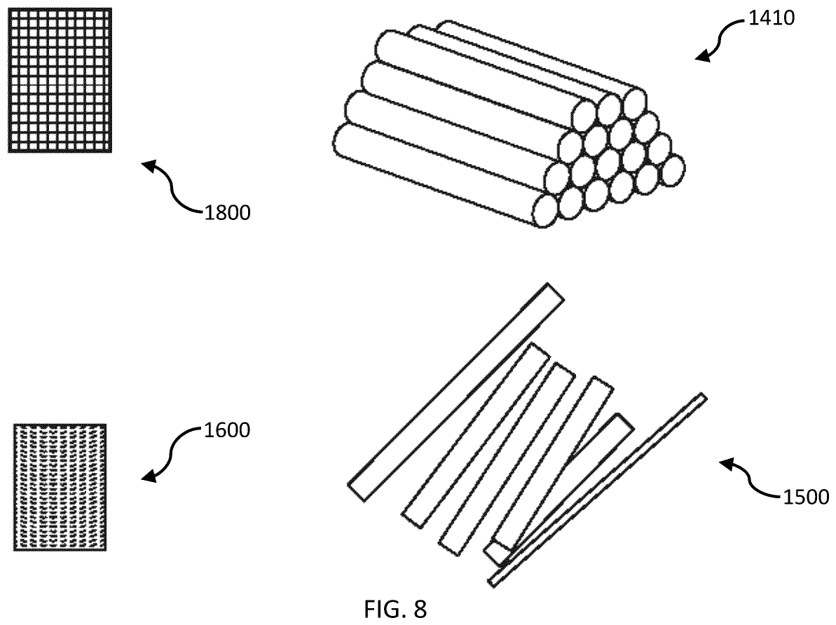

Referring to FIGS. 7 & 8, disclosed crematories may be provided as a collection of components or a kit including a plurality of fire bricks 1200, a plurality of solid cylinders 1410, a grate 1430, a frame pieces 1500 and a plurality of air filters 1600 configured for secure receipt within frame 1500. Solid cylinders 1410 may be provided in any of a variety of diameters and lengths suitable for supporting grate 1430 above a lower chamber. In an example, solid cylinders 1410 are about 3 ft. wide and have a 2 in. diameter. Air filters 1600 may be configured for operating temperatures up to 900° F.

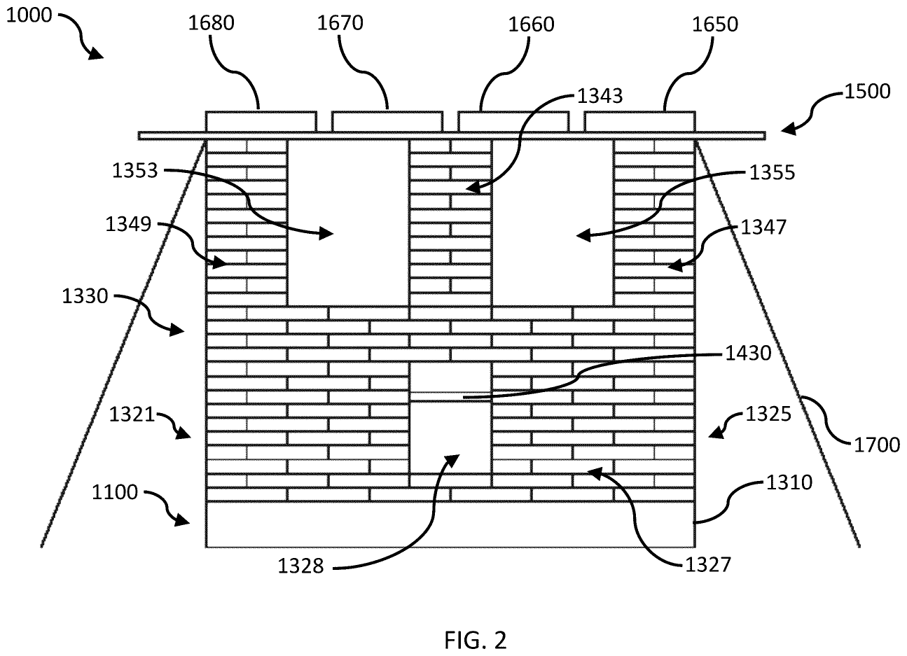

The collection may further include a plurality of guy lines or cables 1700 (FIGS. 2 & 3), a fire screen mesh 1800 and a volume of sand 1120. The kit may also include instructions for assembling the components into a usable crematory. In an example, the instructions are provided in print. In another example, the instructions are provided digitally. Finally, the kit may include wood 3000 for fuel for the crematory. In an example wood 3000 is a combination of wedges and kindling pieces and may be any of a variety of types including but not limited to oak and/or hickory.

Disclosed crematories and/or associated collections or kits may be assembled in accordance with any of a variety of methods. According to an example method, a crematory site is selected that is distant from structures, trees and vegetation. In an example, the crematory site selected is at least 0.5 M away from structures, trees and vegetation.

The method continues with forming a floor and forming left side, rear, right side, and front walls so as to rise from the floor, meet at four corners and surround a lower chamber with ports passing through each of the walls to outside the lower chamber. The floor may be formed from laid fire bricks. In an example, the fire bricks are laid to form a rectangle 3 ft. by 8 ft. While the fire bricks may be laid in any of a variety of configurations to form the floor, in an example, all fire bricks may be laid in stretcher orientation to form the floor. While the fire bricks may be laid in any of a variety of configurations to form the left side, rear, right side, and front walls, in an example, fire bricks are laid in a series of pairs in alternating stretcher and header orientation pairs.

The method continues by spanning the front and rear walls with a number of cylinders suitable to, in a mutually parallel orientation, cover the length between the left side wall and the front port plus the length between the right side wall and the front port. A grate is placed or laid on the cylinders. A rim is formed so as to rise from the side walls above the grate around an upper chamber. In an example, the rim takes a generally rectangular shape. The left side, rear, right side, and front walls and the rim may be formed such that a perimeter of the lower chamber is smaller than a perimeter of the upper chamber.

The floor, the walls, the rim and the columns may be formed by stacking fire bricks with dry-stone masonry. The rim may be formed on the walls with a series of single fire bricks in stretcher orientation such that each wall has a length which is a multiple of a length of a fire brick and a height which is a multiple of a height of a fire brick. First, second, third and fourth columns are formed so as to rise from the rim at each of the four corners. A fifth column may be formed so as to rise from the rim between the first and second columns. The columns may be erected with a series of levels each formed from a pair of the fire bricks.

A plurality of air filters are framed for spanning the columns. In an example, eight air filters are placed into/onto the frame. The filter frame is set on top of the five columns. The framed air filters may be configured for operating temperatures up to 900° F.

The method may further include draping a fire screen mesh over the filter frame, columns, rim and walls to cover the ports and windows between the columns. Alternatively or additionally, a fire screen mesh may be wrapped around the columns.

The method may further include coupling guy lines between the filter frame and ground anchor points. A first guy line may be drawn from a first anchor point upwards at an angle to a top of a first column, wrapped around the upper layer of the first column, drawn to an adjacent, second column, wrapped around the upper layer of the second column and then drawn downwards at an angle to a second anchor point. A second guy line may be drawn from a third anchor point upwards at an angle to a top of a third column, wrapped around the upper layer of the third column, drawn to an adjacent, fourth column, wrapped around the upper layer of the fourth column and then drawn downwards at an angle to a fourth anchor point.

The method may further include providing a stand-off on the grate inscribed by the interior perimeter of the upper chamber.

For additional protection from radiation, disclosed crematories may be constructed within a pit. In an example, a pit is excavated in the shape of an inverted trapezoidal prism having a height or depth of 12 ft. and a minor or lesser base of 20 ft. by 30 ft.

For additional stability, disclosed crematories may be provided with a foundation or base. Rebar is laid over a 10 ft. by 20 ft. region of the minor/lesser base of the trapezoidal prism and a 1 ft. thick monolithic concrete slab is poured so as to embed the rebar. The floor may be formed on a 4 in. base of levelled sand covering the concrete slab.

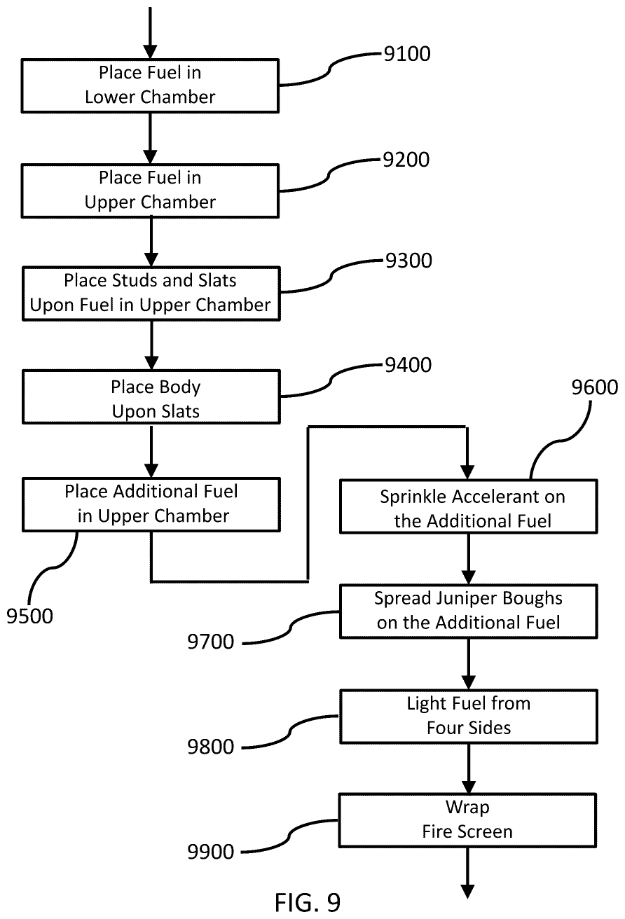

Disclosed crematories may be suitable for use in association with any of a variety of methods. Referring to FIG. 9, according to an example method for using a crematory, with a grate about 16 in. above a floor and defining a lower chamber upper extent, at 9100 fuel is placed in the lower chamber. A first layer of large oak and/or hickory wedges is stacked in a lower chamber against first, second, third and fourth walls to a height of about 14 in. A first layer of kindling pieces is stacked inside the large oak and/or hickory wedges to a height of about 14 in. and/or level with the large oak and/or hickory wedges. Spaces between stacked kindling pieces are filled with balled paper to a height of about 14 in. and/or level with the large oak and/or hickory wedges and/or level with the kindling pieces. In an example, the grate rests about 2 in. above the stacked wedges, kindling and balled paper of the first layer.

At 9200, fuel is placed in a upper chamber on the grate. A second layer of large oak and/or hickory wedges is stacked in the upper chamber against a rim to a height of about 4 in. above the grate. A second layer of kindling pieces is stacked inside the second layer of stacked large oak and/or hickory wedges to a height of about 4 in. above the grate and/or level with the second layer of large oak and/or hickory wedges. Spaces between stacked kindling pieces are filled with balled paper to a height of about 4 in. above the grate and/or level with the second layer of large oak and/or hickory wedges.

The method continues with placing studs on top of the second layer of large oak and/or hickory wedges and the second layer of kindling pieces and then spanning the studs with slats about 2 in. above the grate at 9300. The studs and slats form a pseudostretcher for the body. The body is placed onto the slats of the pseudostretcher at 9400 and the upper chamber, above the body, is filled with large oak and/or hickory wedges and kindling pieces at 9500. Accelerant is sprinkled on the large oak and/or hickory wedges and kindling pieces at 9600 and juniper boughs are spread over the large oak and/or hickory wedges and kindling pieces at 9700.

At 9800, an incinerating fire is ignited through each of four ports through the first, second, third and fourth walls into a lower chamber substantially simultaneously and/or contemporaneously. At 9900, a fire screen mesh is wrapped around the columns. After three to four hours at 1500-1700° F, the body and fuel have been incinerated and the resulting ashes have fallen through the grate to the pyre floor where they may be collected for presentation to the next of kin.

Embodiments of the disclosure are susceptible to being used for various purposes, including, though not limited to, enabling open-air cremation which mitigates pollution and wildfire risk while offering portability.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

1. A crematory, comprising:
a floor;
left side, rear, right side, and front walls rising from the floor and meeting at four corners to surround a lower chamber with ports passing through each of the walls to outside the lower chamber;
a grate resting above the sidewalls;
a rim rising from the side walls around an upper chamber above the grate;
first, second, third and fourth columns rising from the rim above each of the four corners; and
supported by a frame spanning the columns, a plurality of air filters.

2. The crematory as set forth in claim 1, wherein a perimeter of the lower chamber is smaller than a perimeter of the upper chamber.

3. The crematory as set forth claim 1, further comprising a fifth column rising from the rim between the first and second columns.

4. The crematory as set forth claim 1, wherein the floor, walls, rim and columns further comprise dry-stone masonry.

5. The crematory as set forth claim 1, wherein the floor, walls, rim and columns further comprise stacked fire bricks.

6. The method as set forth claim 5, wherein the first, second, third and fourth columns further comprise a series of levels each including a pair of the stacked fire bricks.

7. The crematory as set forth claim 1, wherein the grate is supported by a plurality of cylinders spanning two of the first, second, third and fourth walls.

8. The crematory as set forth claim 1, further comprising guy lines coupled with the filter frame.

9. The crematory as set forth claim 1, further comprising a fire screen mesh wrapping the columns and windows defined therebetween.

10. A method for assembling a crematory, comprising:
forming a floor;
forming left side, rear, right side, and front walls so as to rise from the floor, meet at four corners and surround a lower chamber with ports passing through each of the walls to outside the lower chamber;
spanning two of the walls with a plurality of cylinders;
laying a grate on the cylinders;
forming a rim so as to rise from the left side, rear, right side, and front walls above the grate around an upper chamber;
forming first, second, third and fourth columns so as to rise from the rim above each of the four corners;
framing a plurality of air filters; and
spanning the columns with the framed air filters.

11. The method as set forth claim 10, wherein the forming the left side, rear, right side, and front walls and the forming the rim further comprise forming such that a perimeter of the lower chamber is smaller than a perimeter of the upper chamber.

12. The method as set forth claim 10, further comprising forming a fifth column so as to rise from the rim between the first and second columns.

13. The method as set forth claim 10, wherein the forming the floor, the forming the walls, the forming the rim and the forming the columns further comprise forming with dry-stone masonry.

14. The method as set forth claim 10, wherein the forming the floor, the forming the walls, the forming the rim and the forming the columns further comprise stacking fire bricks.

15. The method as set forth claim 14, wherein the forming first, second, third and fourth columns further comprises forming each of a series of levels from a pair of the fire bricks.

16. The method as set forth claim 10, further comprising coupling guy lines between the filter frame and ground anchor points.

17. The method as set forth claim 10, further comprising wrapping a fire screen mesh around the columns and windows defined therebetween.

18. A crematory kit, comprising:
a plurality of fire bricks;
a plurality of solid cylinders;
a grate;
a frame; and
a plurality of air filters configured for secure receipt within the frame.

19. The crematory kit as set forth claim 18, further comprising a plurality of guy lines.

20. The crematory kit as set forth claim 18, further comprising a fire screen mesh.
